(19) United States
(12) Patent Application Publication
(10) Pub. No.: US 2010/0253578 A1
(43) Pub. Date: Oct. 7, 2010

(54) NAVIGATION DATA ACQUISITION AND SIGNAL POST-PROCESSING

(76) Inventor: Jose R. B. Mantovani, Los Altos, CA (US)

Correspondence Address: Thomas E. Schatzel;Law Offices of Thomas E. Schatzel, P.C., 200 Altura Vista, Los Gatos, CA, 95032, US

(21) Appl. No.: 12/740,027

(22) PCT Filed: Nov. 24, 2008
(86) PCT No.: PCT/US2008/013063

§ 371 Date: Apr. 27, 2010

Related U.S. Application Data
(60) Provisional application No. 60/989,945, filed on Nov. 25, 2007.

(51) Int. Cl. G01S 19/36; G01S 19/37; G01S 19/38

(52) U.S. Cl. 342/357.76; 342/357.77; 342/357.78

(57) ABSTRACT

A navigation system comprises a radio receiver for the data acquisition of navigation satellite signals, a memory in which to store samples of those signals, and a post-processing unit to replay and signal-process the data in the memory to extract an original position fix for the radio receiver when it acquired the original navigation satellite signals.

### RELATED APPLICATIONS

This Application claims benefit of U.S. Provisional Patent Application 60/989,945, filed Nov. 25, 2007, titled, GNSS RECEIVER WITH SEPARATE DATA ACQUISITION AND SIGNAL PROCESSING AND RELATED METHODS AND APPARATUS.

### BACKGROUND OF THE INVENTION

1. Field of the Invention

The present invention relates to navigation satellite systems, and in particular to devices for position solutions in which the data acquisition and signal processing are separated in time and space, and when the position solutions are not needed in real-time and can be batch processed.

2. Description of the Prior Art

Fundamentally, global navigation satellite system (GNSS) receivers are expected to provide a position fix, either described by latitude, longitude and altitude, or by an icon on a map. As a byproduct, GNSS receivers can also provide speed, heading, and very accurate time information. Fully autonomous GNSS receivers, ones without any kind of time, position, Doppler, or almanac aiding information obtained from external sources, can produce first fixes only after considerable delays in searching for the fast changing signals from the orbiting satellites.

The long times needed to obtain a first position fix in fully autonomous GNSS receivers can consume a substantial amount of battery power in portable devices. In many applications, the GNSS receiver must be left on, so updated position fixes are available to associate with photographs and other objects.

The sensitivity of a radio receiver is a measure of the minimum radio frequency signal strength necessary for the receiver to operate. In autonomous GNSS receivers, the received signal strengths must be good enough to be able to demodulate the Navigation Message data broadcasts by the satellites.

Assisted-GNSS receivers require much less time to obtain a first fix because the Dopplers, almanac, time, and ephemerides are all handed over in the aiding data and do not need to be obtained from the signal broadcast by the satellites. Correlation processing gains in the accumulators allow the pseudoranges to be obtained with signals so faint they are deeply buried in the noise. So if the Navigation Message doesn't have to be demodulated, the effect is a GNSS receiver that has far greater sensitivity. In fact, some assisted-GNSS receivers are so sensitive they can operate indoors and below decks in boats.

The GNSS assistance is needed prior to the position fix attempt, and can be obtained over a live data connection to a server, beacon, or through synthesized assistance. Any data used to generate synthesized assistance will have a maximum expiration of only a few days. After that, another data connection to the server needs to be re-established to get fresh information. Synthesized assistance also needs to get a rough position of the user so the aiding information can be constructed to be particularly relevant and useful. For example, Doppler information is specific to unique small regions, so which region the user is in becomes very important to knowing what information needs to be sent.

In general, both non-assisted and assisted receivers are expensive as they typically require special hardware to do the signal correlation. In the cases where the GNSS receiver is integrated with other devices, it typically doesn't share the existing memory in the data acquisition device. Positions are typically calculated once a second, and that may not give enough spatial resolution for fast moving devices and applications.

### SUMMARY OF THE INVENTION

Briefly, a navigation system embodiment of the present invention comprises a radio receiver for the data acquisition of navigation satellite signals, a memory in which to store samples of those signals, and a post-processing unit to replay and signal-process the data in the memory to extract an original position fix for the radio receiver when it acquired the original navigation satellite signals.

An advantage of a navigation system embodiment of the present invention is a position fix can be obtained when aiding information is needed but none is available at the moment.

Another advantage of a navigation system embodiment of the present invention is a position fix can be obtained even when the receiver was not operated long enough at the moment.

A further advantage of a navigation system embodiment of the present invention is a position fix can be obtained even when the receiver was not operated longer than a second.

A still further advantage of a navigation system embodiment of the present invention is a position fix can be obtained at very little power cost from a battery in a portable unit.

Another advantage of a navigation system embodiment of the present invention is that a sequence of position fixes can be obtained with very short time intervals between them, which can be in the order of milliseconds, as opposed to one second, typical in conventional devices.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1 is a functional block diagram of a system embodiment of the present invention that includes at least one GNSS data acquisition unit and one post-processor;

FIG. 2 is a functional block diagram of a GNSS data acquisition unit embodiment of the present invention;

FIGS. 3A-3C are functional block diagrams of three different configurations of a GNSS data acquisition unit and a memory in combination embodiments of the present invention; and

FIG. 4 is a flowchart diagram of a method embodiment of the present invention in which Doppler shift measurements are used to resolve the integer ambiguities and provide faster times to a first position fix.

### DETAILED DESCRIPTION OF THE PREFERRED EMBODIMENT

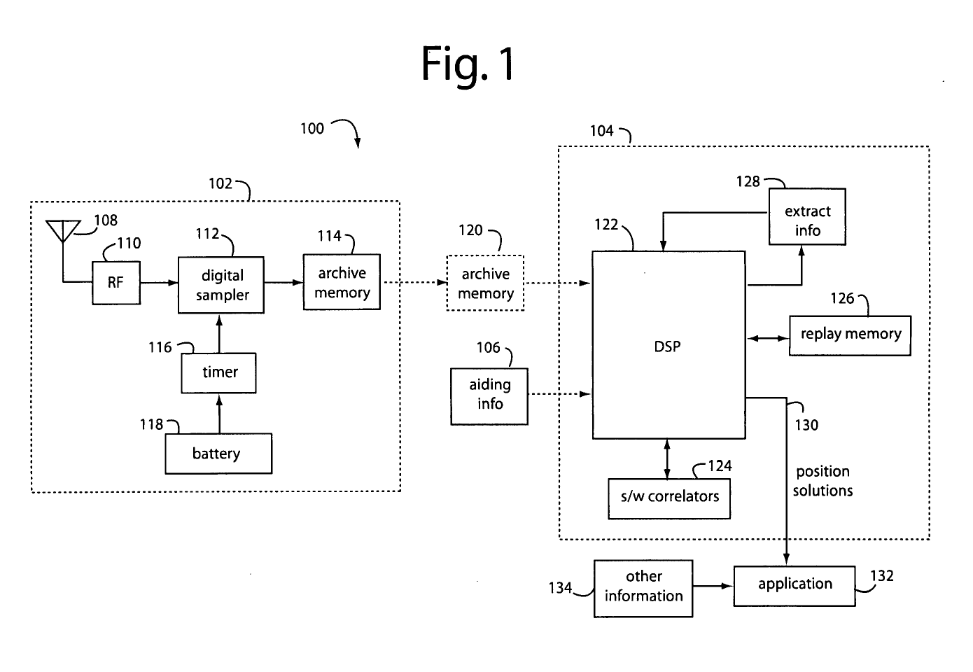

FIG. 1 represents system embodiment of the present invention, herein referred to by the general reference numeral 100. The system 100 comprises an independent GNSS data acquisition unit 102 that collects raw digitized radio frequency (RF) or intermediate frequency (IF) data sampled from GNSS satellite transmissions. Several GNSS data acquisition units 102 may be used to independently collect GNSS satellite transmissions corresponding to the places and times they were operated, and a single GNSS data acquisition unit 102 may be deployed at different times and to different places if the schedule for that is practical.

A single post-processor 104, or a number of them, can then be used to respectively batch process the raw digitized RF or IF data samples. It will extract at least the position of the respective GNSS data acquisition unit 102 when it collected the corresponding raw digitized RF or IF data samples. The post-processor 104 can also be used to extract velocity, time, and other navigation data about the movements and places visited in the past by the GNSS data acquisition units 102 that correspond to the collected raw digitized RF or IF data samples.

An aiding information message 106 may be provided by an external GNSS assistance server that includes aiding information relevant to the place and time the raw digitized RF or IF data samples were collected and reported. Such aiding information can be as simple as information needed for differential correction, or as ambitious as the complete almanacs, ephemerides, Dopplers, and time information needed to do quick, high sensitivity, indoor GNSS position fixes. The aiding information could also include raw data bits broadcast by satellites for use in data wipe off techniques. Such aiding information message 106 could be provided by an Internet server on a subscription basis.

The aiding information message 106 can be received well after the raw digitized RF or IF data samples were collected, and anytime before the samples need to be processed for position solutions.

The raw digitized RF or IF data samples from each independent GNSS data acquisition unit 102 can be delivered to post-processor 104 on any suitable storage media or communications device. For example, USB drives, SD-cards, Internet, telephone, wireless, etc. Such delivery is one-way, and need not be effected in real time. There is no practical limit on the delivery delays involved. The raw digitized RF or IF data samples are tagged according to some identifying device, in order to distinguish them from one another.

The raw digitized RF or IF data samples are collected at a time and place that has some significance to some third-party. For example, the location a photograph or video frame was taken. The identifying device is used to associate the raw digitized RF or IF data samples and their eventual position solution to the creation of the photograph or video frame. It can be important to know where and when exactly such photograph or video frame was taken, e.g., to identify or inventory an object pictured, or to enable time synchronization of video frames.

GNSS data acquisition unit 102 includes a microwave antenna 108, a radio frequency (RF) front end 110 for receiving GNSS signals from orbiting satellites and down-converting them to an intermediate frequency (IF). A digitizer 112 is used to sample the RF, IF, or baseband, and it collects the raw data for storage in a non-volatile archive memory 114. Such can be a flash memory type like those used universally in USB-drives and SD-cards.

A timer 116 limits how long and when the RF 110 and digitizer 112 are operated and used to collect the raw data for storage in an archive memory 114. The length of operation can be exceedingly short, less than one second. This helps to extend the life of a battery 118. The data collected can even be as short as a one millisecond record, because the GNSS data acquisition unit 102 will be able to play the samples over and over again to do all the necessary carrier and code searches for acquisition and tracking. The GNSS data acquisition unit 102 will also be able to apply hundreds or even thousands of software correlators, because the replay and correlation need not proceed in real-time. The aiding information message 106 will further assist in being able to extract useful navigation solutions from even so brief a sample record as one millisecond.

In one embodiment, for example, the whole GNSS data acquisition unit 102 could be built into a memory card or USB drive, and such could be plugged into a camera. The camera would then trigger the GNSS data acquisition unit 102, and the raw digital data samples it took would be associated by ID tags with the pictures created. The memory card or USB drive would then be removed and delivered sometime later to a post-processor 104 to obtain the position solutions for the pictures taken.

Post-processor 104 includes an input 120 to receive the GNSS data samples collected, and a baseband digital signal processor (DSP) 122 for extracting navigation position solutions from digitized samples of downconverted GNSS transmission. Various commercially marketed single-chip solutions for DSP 122 include Vespucci STA2051 GPS controller by STMicroelectronics, but it may be advantageous to use software implementations of correlators 124. Software defined radio (SDR) applications such as a software GPS receiver (SGR) are commercially available that will run on a personal computer, and work with data obtained from RF sensors. For example, SGR and PC/104 Standard products from NAVSYS Corporation (Colorado Springs, Colo.).

A replay memory 126 allows the GNSS data samples collected to be played over and over using various frequency and codephase hypotheses to search for and track the satellite vehicles recorded. Extracted information 128 gathered and accumulated from the replays is used in refining the searches and tracking as more intelligence is extracted in each replay of the GNSS data samples collected. A final result is an output 130 for position solutions that can then be used in an external application 132.

Other pieces of information 134 can be provided to the external application, such as digital picture or video files. The external application may associate the position solutions with these other pieces of information.

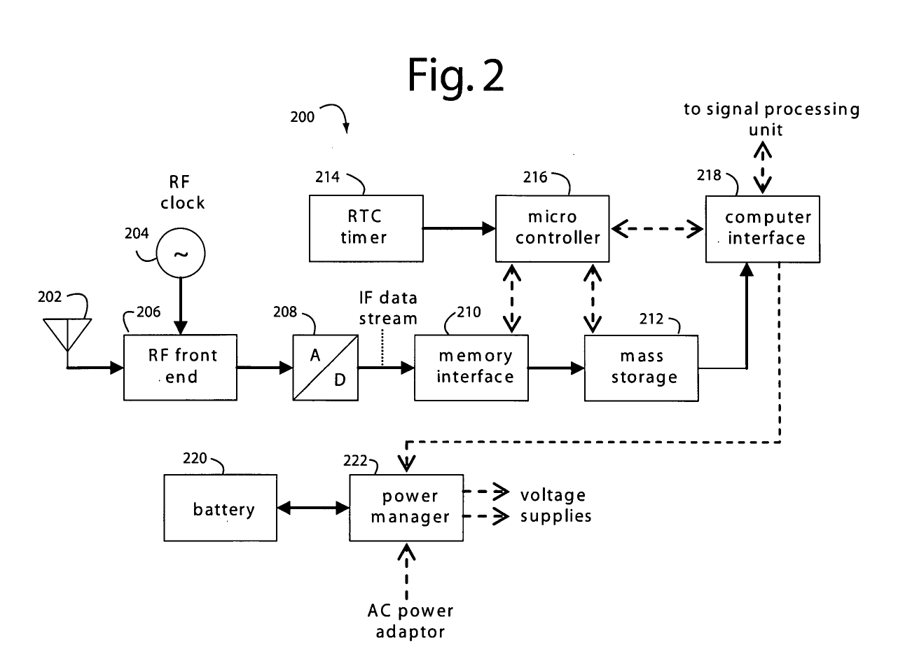

FIG. 2 represents a GNSS data acquisition unit 200 in an embodiment of the present invention. The GNSS data acquisition unit 200 comprises an antenna 202, an RF clock 204, an RF front end 206, an analog-to-digital converter (ADC) 208 to digitize samples into an IF data stream, a memory interface 210, a mass storage unit 212, a real time clock (RTC) 214, a microcontroller 216, a computer interface 218, a battery 220 for portable operation, and a power manager 222. It may further include inertial guidance components like accelerometers and compasses to add to the information obtained during operation.

RF front end 206 is used to tune the RF signal from the GNSS satellites which are received by antenna 202. These are down-converted, e.g., to an intermediate frequency (IF) which can be several MHz, baseband DC (zero-IF receiver), or very close to zero (near-zero IF receiver). In the first case, the output will be a single signal, and in the zero IF or near-zero IF cases, in-phase (I) and quadrature (Q) signals are produced for sampling. As the technology develops in the future, the samples could be taken without any down conversion, e.g., at the original RF frequencies.

The analog signal data is sampled and digitized by a single or dual ADC 208. The sampling frequency and the number of ADC bits in each sample are predetermined. A one-bit ADC is typical. The output of the ADC 208 is a data stream at a rate of several mega-bits per second (MBPS).

The data stream goes through a memory interface 210, typically a first-in, first-out (FIFO) buffer with some additional control logic, and ends up being stored in mass storage device 212. This is typically a NAND flash memory chip or a hard disk drive. A computer interface 218, typically a USB interface, allows the stored data to be transferred to a personal computer, or other device.

The RTC 214 provides a time stamp for association with each data acquisition block. The RTC 214 typically uses a 32.768 kHz crystal based oscillator which can be kept running continuously because such watch crystal oscillators consume very little power. Alternatively, the RTC timer can include some form of temperature compensation (TCXO) in order to improve the clock frequency tolerance over the operating temperature range of the data acquisition device. The better the accuracy of the acquisition time stamp, the easier will be the task of signal processing to obtain an unambiguous position fix.

Although helpful, the inclusion of RTC 214 is not strictly necessary. If an RTC is not used, the time information can be obtained some other way to help time stamp the data capture. Or, if no time stamp is used, then the time can be extracted later from the captured data.

If the acquisition unit 200 is connected to a computer or a network at the time of data capture, the time stamp information can be obtained externally. Other radio signals, like the WWV time broadcast by National Institute of Standards and Technology (NIST) could be used to obtain precise time information. Other, less direct methods extract time information from ordinary broadcast signals.

If no time stamp is provided at all, the system resorts to extracting time information from the GNSS data capture. If the capture time window is long enough, e.g., at least six seconds long, the beginning of a GNSS subframe will be captured. And if the RF signal is strong enough to allow for demodulation of the Navigation Message, the time of week (TOW) information from the GNSS system can be demodulated to provide an exceedingly precise time stamp.

If the captured GNSS signals are too faint, the TOW cannot be directly demodulated, and other data alignment techniques must employed during the signal processing. If that produces ambiguous results, the several time possibilities could be screened later using conventional methods.

Operating and battery charging power can be provided externally by an AC adaptor or by a USB or other computer interface. Battery 220 can be rechargeable.

The data acquisition unit 200 can be a stand-alone single purpose device, or built into other devices like photo cameras, camcorders, voice recorders, data recorders and players, memory cards, WLAN accessories, laptops, portable computing devices, PDAs, etc.

The data acquisition process of turning on the power and collecting and recording the datastreams of digitized samples to memory can be triggered manually, like when the user presses a button, or automatically, such as by RTC 214 at a certain pre-programmed time. A single trigger event, a series of trigger events, or a periodic trigger, could all be programmed to respond to signals from a sensor. For example, from an accelerometer when the acceleration exceeds a certain pre-determined threshold. Or by a thermostat, when the ambient temperature exceeds some set-point. Such triggers could also be computed or forwarded by other independent devices.

Further examples of external trigger events include: when a data capture from another device takes place, when a picture is taken with a camera, at the beginning of a movie recording, when a voice recording event occurs, when some data is written to a memory, when a particular type of data is written, when data written exceeds a certain amount, etc.

Triggers can be communicated by wire, wirelessly, optically, by sound, etc. The flash of a camera strobe light, for example, would be one useful way to trigger data acquisition when the picture being taken needs to have position solutions computed for it later.

In some applications, the acquisition units are configured to be constantly storing the GNSS raw IF data. A circular buffer architecture can be used, where old data gets overwritten by new incoming data, allowing the unit to always keep the more recent data up to a certain size limited by the amount of memory available. In this case, a trigger event could be used to stop the acquisition process, as opposed to starting it, as in the previous examples. The actual end of the acquisition collection could be immediate with the trigger, or after a pre-defined time interval following the trigger. Even more elaborate trigger mechanisms could be needed in particular applications. For example, a dual signal approach could be used in which a first signal is used to arm the trigger, while a second signal represents the actual trigger.

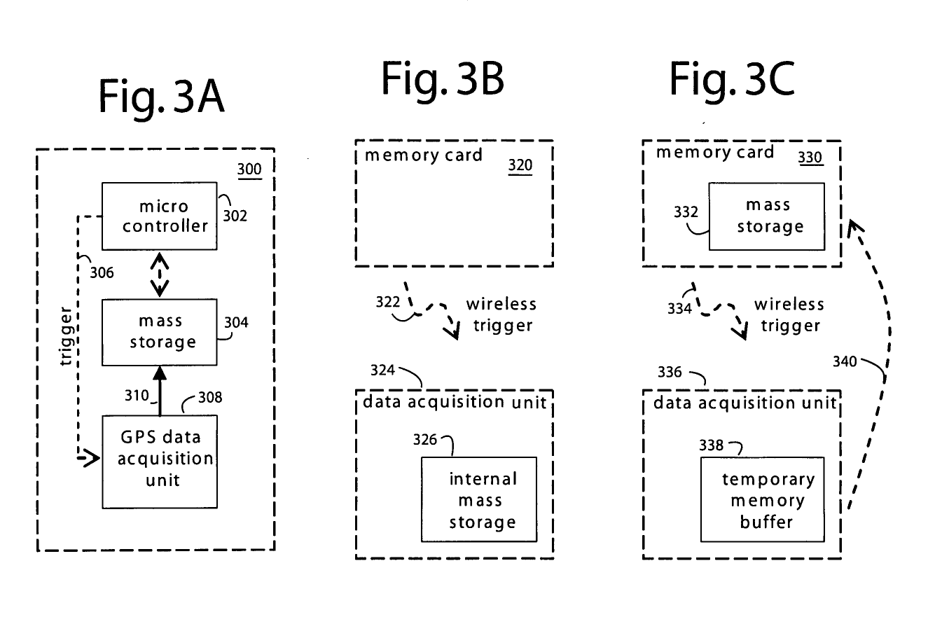

FIGS. 3A-3C represent three different useful configurations for the packaging and operation of a GNSS data acquisition unit like that of FIG. 2. In FIG. 3A, a combined device 300 includes a microcontroller 302 with a mass storage device 304. A trigger 306 can be issued to cause a GNSS data acquisition unit 308 to collect and digitize raw samples 310 that will be deposited in mass storage device 304, whose main function could be to store other types of data, like digital picture, movie, or sound files, for instance.

In FIG. 3B, a memory card 320 is equipped to issue a wireless trigger 322 that will be received by a GNSS data acquisition unit 324. The trigger will cause raw samples to be collected and digitized for deposit into an internal mass storage device 326. In FIG. 3C, a memory card 330 has its own mass storage device 332. A wireless trigger 334 from the memory card 330 is received by a GNSS data acquisition unit 336 to cause raw samples to be collected and digitized for deposit into temporary memory buffer 338. The collected and digitized raw samples are then later transferred by a wireless connection 340 to the memory card 330 and mass storage device 332.

Once a raw GNSS IF signal is stored by a GNSS data acquisition unit and forwarded to a post-processing unit, the data needs to be processed so that a position fix can be extracted. The first step is a satellite vehicles (satellite vehicle's) search. In order to successfully detect the very faint signals from each satellite vehicle, a signal correlation is done between the incoming signal and a local replica of the signal. The signals recorded for each satellite vehicle will have come with a different codephase and different Doppler frequency drifts due to the different satellite vehicle positions and relative approaching speeds. So each combination of the possible codephase and Doppler frequency shifts will be used to define a hypothesis bin. During the code and frequency searches for each satellite vehicle, the correlation process will be repeated for each hypothesis bin until a peak in the correlator output is detected. These peaks indicate the correct codephase and Doppler frequency bin has been found.

In conventional GNSS receivers, keeping up with the real-time data processing requirements is very challenging. So the correlation process is typically implemented with special dedicated hardware integrated into the GNSS receiver.

In most embodiments of the present invention, there are no real-time pressures on the correlation process, and far less expensive correlators can be used. For example, software correlators can be executed by an external, available personal computer.

The general navigation receiver signal processing can be executed by a main host processor, by a specialized co-processor like the Intel MMX co-processors, or by a peripheral controller like a graphics processor unit (GPU). Using GPU's for this type of computation is extremely attractive, given their ability to process simple repetitive parallel operations very efficiently. Most of personal computer GPU vendors, like ATI and NVidia, provide application programming interfaces (API's) to use their processors as general purpose units. Another alternative is to upload the raw GNSS IF data to a server on the Internet, for signal processing itself, or parsing and re-distribution to several specialized servers or general purpose computing machines connected to the Internet in a distributed computing architecture. This could dramatically improve the time required to compute each position fix, as it could leverage various expertise and private libraries.

Once the post-processing has found all the satellite vehicle's, a finer measurement of the codephase and Doppler frequency shifts takes place. The accuracy of the codephase measurements is critical to obtaining good pseudoranges and thereby accurate position fixes.

One particular method to measure codephase accurately is to first correlate the signal with a fabricated replica of the pseudo-noise (PN) sequence, which is unique for each satellite vehicle. When the time alignment between the codephase of the incoming PN sequence and the codephase of the PN replica is exact, when looking at the frequency spectrum of the resulting signal, a line correspondent to the Doppler frequency shift will be seen. If the codephase alignment is not exact, other spectrum lines spaced by the chip rate of the PN sequence (1.023 MHz, for GPS C/A code) will be observed. As any misalignment grows, the amplitudes of the other frequency components also grow. Therefore, the correct codephase can be determined by choosing the code alignment that minimizes the amplitude of the higher frequency spectrum line components.

A next step in the post-processing is to solve the navigation equation (Eq. 1), a set of equations where three user position quantities and one absolute receiver clock offset quantity are the unknowns. In a conventional approach, it is assumed that the satellite vehicle positions are known, because the almanac and ephemerides in the Navigation Message describe where they are, once the correct time of transmission for each satellite is known.

Since there are four unknowns, measurements from at least four satellite vehicles will need to be measured to determine the position. Each satellite vehicle measure contributes one piece of the puzzle in the 4-way simultaneous equation. The pseudoranges are assumed to be known, because they can be measured. The pseudoranges represent the distance between the user and each satellite vehicle, plus an offset common to all the satellite vehicles. The pseudoranges are determined from the codephase measurements and the transmit time for each satellite vehicle.

For each satellite vehicle #j of interest:

ρⱼ=∥\vec{p}ⱼ−\vec{u}∥+c·(tᵤ−δtⱼ) (1)

where,
ρⱼ is the pseudo range of satellite vehicle #j—measured based on fine codephase and transmit time extraction;
c is the speed of light—known;
\vec{u} is the user position—unknown to be determined;
\vec{p}ⱼ is the position of the satellite vehicle #j—obtained from ephemeris and time information;
tᵤ is receiver common clock time offset—unknown to be determined; and
δtⱼ is the clock offset correction for satellite vehicle #j—based on ephemeris information.

Two pieces of information are needed about each satellite vehicle to determine their positions at any one instant. The ephemeris, which is a set of parameters that define the satellite vehicle orbit model, and the corresponding time the signal used for the measurement was transmitted.

The determination of the transmit time for each satellite vehicle is critical to solving the navigation equation system. The transmit time can be identified by analyzing the data sequence of the incoming signal, and determining where that particular part fits in the entire pseudorandom code sequence launched every millisecond by the satellite. Or, the transmit time can be included as an extra unknown in the solution of the navigation equation system.

In the first case, the problem basically consists in aligning the code sequence of the received signal with the part of the code sequence of the expected signal. If a data acquisition unit 102 (FIG. 1), for example, captures data over a relatively long time window, it may have collected enough information in its samples to be able to solve the transmit time mystery. For instance, if the signal level is strong enough to allow reliable data decoding and if the data capture is at least six seconds long, the data demodulated by post-processing unit 104, for example, should have the time of week (TOW) time stamp. This would unambiguously allow the transmit time determination.

If the data capture window is smaller, but still long enough to contain several data bits (20 ms each, for GPS C/A code), and if data bit transitions occur in the time window when data capture occurs, conventional data alignment techniques could be used for different alignment hypotheses. Any assistance server, like 106 in FIG. 1, should be able to provide GNSS broadcast data bit sequence information.

Such data bit sequences can also be used in the search process for data wipe-off techniques and further increase the processing gain of the correlation process. Although computational intensive, this technique can potentially increase the sensitivity of the receiver beyond the levels of conventional assisted-GNSS receivers.

There are cases where there will be no data bit transition captured in the data time window. This is particularly critical when the data acquisition happens during the subframes 4 or 5 of the GNSS signal structure, for GPS C/A code. In some instances, these time windows with no bit transition can be longer than one second. In these cases, the data alignment technique cannot be used for transmit time extraction purposes.

If the time stamp information is accurate enough to determine whether a trigger event occurs within a time interval with high probability of having no bit transition, micro-controller 216, for example, could postpone the data acquisition process to a time window where bit transitions do have high probability of occurring. Alternatively, a dual data capture could be performed, the first at the instant of the trigger, and the second one later in time during a more favorable time window. The second data capture could be analyzed to extract precise time information. This precise time can then be used to line up the first data capture with the GNSS signal to within one millisecond, the duration of the PN code, by determining the amount of time that elapsed between the first and second data capture. The geo-location of the first data capture, at the instant of the trigger, can thus be determined precisely by analyzing the second data capture to extract fine timing information.

If the time stamp is not accurate enough to determine whether a trigger occurs during an unfavorable time window, or if there is no time stamp at all, then the data capture time duration could be extended to increase the probability of occurrence of a bit transition within the data capture. This has a high cost in terms of memory space, as it may be needed to capture several seconds worth of data. Acquisition could take place during multiple relatively short time windows. The windows would be properly spaced in time among them to maximize the probability of a bit transition occurrence within at least one of the time windows. If a previous data acquisition allowed for transmit time extraction and the timestamp information is accurate enough to determine the time interval between the earlier and the current data captures, it is possible to determine the transmit time of the current data capture by adding the time stamp difference to the transmit time obtained from the earlier data capture. The time interval between the two data captures, associated with the maximum unpredictable time drift of the time stamp, will determine whether or not this technique can provide a propagated time with enough accuracy necessary for time extraction purposes.

Another, very different approach is to include the transmit time as unknown in solving the navigation equation system. In this instance, it will be important to know the coarse difference integer number of milliseconds in propagation delays among the satellite vehicles being used. This way, the transmit time can be represented by a single unknown among all the satellite vehicle's, as opposed to an independent unknown for each satellite vehicle. Consequently, the number of unknowns in the navigation equation system increased from four to five. Consequently, at least five satellite vehicles are now required to solve the equation system.

One way to determine the coarse differences in the propagation times from each of the satellite vehicles is to have the coarse position information of a neighbor. Such typically needs to be no more than 150-kilometers from the real position to provide unambiguous propagation time difference information. The PRN code sequences transmitted by the satellite vehicles repeat every millisecond, and the signals will propagate 300-kilometers in that time. If the position uncertainty is greater than half that, 150-kilometers, it becomes necessary to try a different hypothesis in terms of coarse propagation time difference. In conventional assisted-GNSS systems, this coarse position information is called the z-count or integer millisecond, and saves a great deal of time and effort by not having to solve the so-called integer ambiguity problem.

In conventional approaches, the Doppler frequency equation system is used to determine the user's speed and the frequency offset of the receiver clock once the user position is already determined by solving the pseudorange equation system.

Embodiments of the present invention assume the user's speed is negligible when using the Doppler frequency equation systems. Coarse time stamping is used for the satellite vehicle position and speed determination. Doppler shift measurements can instead be used backwards to solve for a rough user position. A position solution can be then calculated with this head start in pseudorange equations, and a final, accurate position is thus obtainable very quickly.

But because Doppler shift measurements are not as accurate as codephase measurements, and because coarse time information is being used, the resulting calculated positions are not as accurate as the ones obtained from pseudorange equations. However, in many cases, the Doppler shift measurement determination of user position will be accurate enough to be used as a coarse position for then determining the coarse propagation time differences among the satellite vehicles. At a minimum, it will be accurate enough to limit the coarse propagation time difference hypotheses to a much smaller number of possibilities.

Once a coarse position is obtained, pseudo-range equations can be used to determine a fine position fix and the absolute transmit time. After any corrections for the codephase and satellite vehicle clock offsets, the transmit time can be rounded to the nearest integer multiple of milliseconds, or to the nearest multiple of twenty milliseconds if the bit transition instant is known. Data alignment techniques can also be used to offset the transmit clock by additional multiples of twenty milliseconds. Once the adjusted transmit time is obtained, the position determination can be further refined by solving the navigation equation system using the fixed transmit time.

The Doppler Frequency Shift Equation System for each satellite vehicle #j of interest is,

$$c \cdot \frac{( {f}_{j} - {f}_{{T}_{j}} )}{{f}_{{T}_{j}}} = \frac{( {{v}^{->}}_{j} - {u}^{{.}^{->}} ) \cdot ( {u}^{->} - {{p}^{->}}_{j} )}{‖ {u}^{->} - {{p}^{->}}_{j} ‖} - c \cdot {\dot{t}}_{u} \qquad ( 2 )$$

where,
c is the speed of light;
fⱼ is the carrier frequency shift for satellite vehicle #j includes Doppler shift, is measured based on the fine frequency information;
f_{T}_{ⱼ} is the transmitted carrier frequency of satellite vehicle #j (1.57542-GHz minus satellite vehicle clock frequency error for the L1 band), a known;
\vec{v}ⱼ is the vector velocity of satellite vehicle #j obtained from ephemeris and time information;
{dot over (\vec{u} is the user velocity, assumed to be zero;

\vec{u} is the user position, the principal unknown to be determined;
\vec{p}ⱼ is the position of the satellite vehicle #j, which can be obtained from ephemeris and time information; and
\dot{t}ᵤ is the RF clock frequency offset, an unknown to be determined.

Such technique can be used to extend the sensitivity of a receiver without benefit of position aiding to the same levels as conventional assisted-GNSS receivers, where position aiding is provided. The technique can also be used in otherwise conventional assisted-GNSS receivers for carrier-independent assistance, where position aiding is typically not provided, e.g., in a cellphone application where the assistance provider has no access to the serving cell information, or does not know the coordinates of the serving cellular basestation.

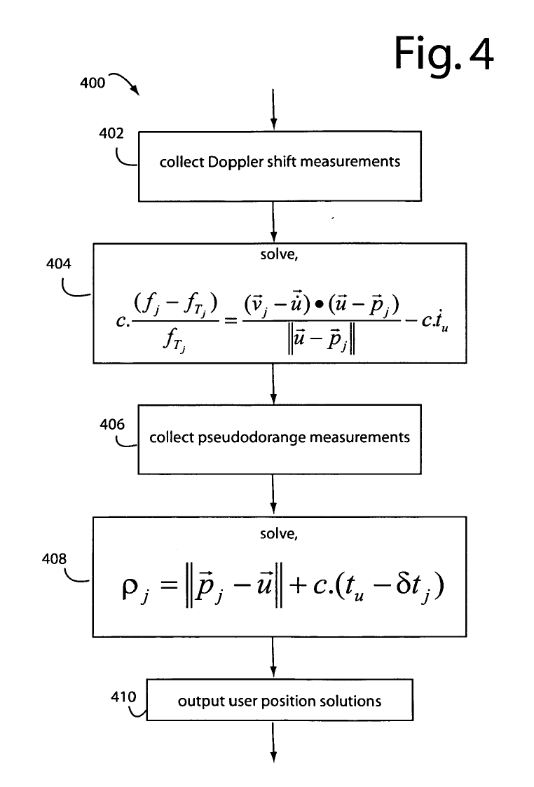

FIG. 4 represents a method 400 for improving the time and reducing the effort needed to produce a first position fix, even without position aiding information. Method 400 comprises two parts, one in which a coarse position is found using the Doppler shift measurements described above, and the second part in which the coarse position found is used to assist the solution of pseudorange equations. Specifically, a step 402 obtains Doppler shift measurements needed to be input to equation-2,

$$c \cdot \frac{( {f}_{j} - {f}_{{T}_{j}} )}{{f}_{{T}_{j}}} = \frac{( {{v}^{->}}_{j} - {u}^{{.}^{->}} ) \cdot ( {u}^{->} - {{p}^{->}}_{j} )}{‖ {u}^{->} - {{p}^{->}}_{j} ‖} - c \cdot {\dot{t}}_{u} .$$

A step 404 solves equation-2 and yields a coarse position solution, in which the user position has no pseudorange integer ambiguities to any observable satellite, or in which the number of possible user positions is reduced to a small set of solutions due to the pseudorange integer ambiguities. A step 406 measures the pseudoranges to the observable satellites. A step 408 solves equation-1, ρⱼ=∥\vec{p}ⱼ−\vec{u}∥+c·(tᵤ−δtⱼ), making use of the coarse position obtained earlier. A step 410 outputs a finely detailed, accurate user position solution.

The positions obtained give the user positions at particular instants in time. These instants are arbitrarily chosen, and could occur at any point in the data acquisition period. Any arbitrarily chosen measurement instant must be defined to properly compensate for the drift of the correlation peak over the integration period due to changes in the user-to-satellite vehicle distance. Even when correlating the incoming signal over a relatively long period of time.

In conventional GNSS receivers, the raw GNSS IF data must be processed in real time, and a new measurement is typically taken every second. Determining the position between two measurement instants is not possible, since the data needed for the interpolation is probably already discarded.

Embodiments of the present invention are not so limited. The original data can be re-processed to recalculate positions at any instants in the collection time windows. These new user positions can be ascertained using very fine measurement instant intervals. Such can be particularly useful where the detailed trajectories of a user need to be determined, like in accident reconstruction analysis.

Two on-board clocks in GNSS data acquisition unit 200 require calibration, the RTC 214 and the RF clock 204 used by the RF front end 206 and ADC 208. For the RTC, it is usually possible to calibrate any absolute time offsets existing based on the GNSS time data obtained during a successful position fix. The measured offset can be used to re-adjust the RTC time, or just used for compensation in the signal processing unit.

Based on different time offsets for fixes spaced in time, preferably over several days, it is also possible to estimate the RTC frequency offset information which can be used to further refine the time stamp information. It's also possible to estimate the RTC time stamp uncertainty based on how far the time stamp is from the closest clock calibration instant (which can be backward or forward in time) and on the estimated worst case clock drift. This tolerance will be tight when the time stamp is close to a calibration instant, and will progressively grow as the time stamp gets away from the last calibration instant. Any RTC time stamp uncertainty is important in order to limit the time search window when data alignment techniques are used. For each successful new fix, precise time information is obtained, which represents a new time stamp calibration instant. This way, the time stamp tolerance around this new calibration instant can be improved.

The RF clock frequency offset information can be calculated by solving the Doppler frequency equation system, and is either written back to the GNSS data acquisition unit or stored in the signal processing unit. Keeping track of the offset is important in order to narrow the search windows in the Doppler frequency shift dimension during the satellite vehicle search process. This saves processing time required to compute a fix, and appropriately compensates any codephase skew during long integration times.

Any GNSS assistance server providing aiding information messages 106, for example, should be able to provide valid ephemeris information for all the satellite vehicles, and at any given time in the past. To do this, a database must be maintained to archive all the conditions existing around the world with a granularity determined by how fast ephemerides go stale and how often ionospheric corrections need to be updated. Ionospheric corrections provide for improved accuracy, and almanac information helps with satellite vehicle visibility list calculations.

If data wipe-off and/or time extraction based on data alignment techniques are used, the GNSS assistance server should also provide raw data bit sequences for particular satellite vehicles during the time windows of interest.

Such data can come from Jet Propulsion Labs (JPL) and other third party sources. Alternatively, a proprietary data collection network could be built and included. In which case, land stations would be needed in different parts of the world to guarantee that each satellite vehicle will be visible to at least one station at any given time if global coverage is desired. A central server could collect the information from the different stations, combine them, and make it available to all the worldwide users. Redundancy techniques could be deployed to increase the reliability of the system even in the event of failure of individual components.

GNSS signal processor unit embodiments of the present invention can be configured to interface directly to another device's application level layer. The signal processor units can simply provide position, velocity and time information to the application level layer. Or, inputs to the signal processor unit could be included. For example, coarse position aiding information could be provided by a user when clicking on a map or specifying the state or the city where particular GNSS raw data was captured. The user could also help filter out bad position solutions, e.g., when prompted to choose amongst different solution candidates that are otherwise ambiguous to the signal processor unit.

At the applications level, position information can be merged with other captured data, like digital pictures, voice recordings, etc. The association can be based on time stamp matching or some other mechanism. Once geo tagging is finished, sorting and/or grouping based on location, mapping, map matching, filtering based on velocity or acceleration information, and other finishings can be completed. For example, one application could filter out picture files if the associated estimated speed or acceleration of the user (provided by the post-processor) is too high. This technique could automatically detect potential blurred pictures.

Standalone battery operated portable GNSS data acquisition units could be as small as a flash drive or keychain, and could acquire GNSS data when the user presses a button. It could be used whenever the user wants geo tag information. Alternatively, it could be triggered externally by some other event.

GNSS data acquisition units built into other devices like digital cameras, camcorders, voice recorders, media players, etc., can be particularly useful for users who want to associate the location to a particular picture and/or voice description, like utilities maintenance crew, real state agents, police, etc.

GNSS data acquisition unit built in memory cards. If the memory card remains mechanically and electrically compatible with conventional memory cards, this combined device can be used seamlessly inside other existing devices, like digital cameras, camcorders, recorders, etc. If a user is interested in geo-tagging, he/she can do so by replacing a memory card as opposed to buying a brand new device with built in geo-tagging capabilities.

GNSS data acquisition units can act as a data recorder for quick event reconstructions, like in vehicle crashes, in airplane black boxes, or in building demolition. In these cases, the unit would be constantly recording GNSS data of the last fixed amount of time, could be in the order of seconds or minutes. A crash detector, like an accelerometer, could trigger the end of the acquisition process, which could happen at the instant of the trigger or a certain amount of time after that. The unit would have to be robust enough so that at least the mass storage device would survive a possible crash.

GNSS data acquisition unit with large amounts of storage for long time recording of scenarios or test site signals. The data collected can be used to compute positions at a 1000 Hz update rate for comparison with 1 Hz conventional receivers for test purposes, or to optimize detection and/or navigational algorithms by feeding it into the test platform bypassing the RF stage and allowing for playback and reconstruction of the test site conditions.

In one business model embodiment of the present invention, each user would be charged based on the number of position fixes obtained with a data acquisition device 102, 200, 300, 324, or 336, for example. This could be controlled by a GNSS assistance server, which could also incorporate billing functions.

In advertising from local business close to tagged positions, an aiding server could present advertising or pay-per-click links of businesses close to the tagged position, or businesses somehow related to the location being tagged.

Marketing information can be sold that recognizes people vote with their feet. Information about location tags related to a particular class of users, or information regarding the type of users associated to tags within a defined geographic region could be sold for marketing survey purposes. This type of information could be used to characterize life-styles or spending habits of a particular individual or class of individuals; or to characterize the type of individuals that visit a certain location.

Offering and charging for server-side signal processing. The user would upload the raw IF and other collected data, such as the time-stamp, acceleration, compass, etc., to a remote server to be converted to coordinates. Premium fees could be charged for advanced processing, such as data-wipe off or other techniques.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A navigation system, comprising:
a radio receiver for the data acquisition of navigation satellite signals;
an archive memory in which to store samples of those signals as samples records; and
a post-processing unit to replay and signal-process the samples records in the archive memory to extract an original position fix for the radio receiver when it acquired the original navigation satellite signals;
wherein, the radio receiver and archive memory are separate from the post-processing unit, and communicate only the samples records in one direction and not in real-time.

2. The system of claim 1, wherein the post-processing unit filters out file information or uses a tagged artifact if the velocity or acceleration was determined to exceed some threshold.

3. The system of claim 1, further comprising:
a digital media recording associated with a time and place in which the radio receiver acquired said navigation satellite signals and stored said samples records in the archive memory.

4. The system of claim 1, further comprising:
a non-real-time aiding information provided to the post-processing unit, and which was relevant to the time and place the radio receiver acquired said navigation satellite signals and stored said samples records in the archive memory.

5. The system of claim 1, further comprising:
a replay memory available to the post-processing unit for repeated replays of said samples records transferred from the archive memory.

6. The system of claim 1, wherein the post-processing unit measures codephase accurately by first correlating a received signal with a fabricated replica of the pseudo-noise (PN) sequence, and when the time alignment between the codephase of the incoming PN sequence and the codephase of the PN replica are exact, then looking at the frequency spectrum of the resulting signal for a line correspondent to the Doppler frequency shift, and if the codephase alignment is not exact, then other spectrum lines spaced by the chip rate of the PN sequence are observed, and as any misalignment grows, the amplitudes of the other frequency components also grow, and the correct codephase can be determined by choosing a code alignment that minimizes the amplitude of higher frequency spectrum line components.

7. The system of claim 1, wherein any original data is re-processed to recalculate positions at instants in collection time windows, and new user positions are ascertained using very fine measurement instant intervals.

8. The system of claim 1, wherein different time offsets for fixes spaced in time are used to estimate RTC frequency offset information for further refinements of time stamp information, and to estimate the RTC time stamp uncertainty based on how far a time stamp is from a closest clock calibration instant and on an estimated worst case clock drift.

9. The GNSS data acquisition unit of claim 1, further comprising:
a user device capable of providing coarse position aiding information to the post-processing unit, and for allowing a user to select a coarse user position from many candidate positions.

10. A global navigation satellite system (GNSS) data acquisition unit, comprising:
a radio frequency (RF) front end for the acquisition of navigation satellite signals;
a digital sampler for obtaining digital samples of said navigation satellite signals;
a timer for limiting how long the RF front end and digital sampler are operated; and
an archive memory for packaging and storing said I and Q digital samples obtained during a limited time into samples records.

11. The GNSS data acquisition unit of claim 10, further comprising:
an association of said digital samples obtained to an independent object that was contemporaneous with and proximate to the receiver during said limited time.

12. The GNSS data acquisition unit of claim 10, further comprising:
a tag associating said digital samples obtained to a photograph that was contemporaneous with and proximate to the receiver during said limited time.

13. The GNSS data acquisition unit of claim 10, further comprising:
a circular buffer disposed in the archive memory, wherein old data is overwritten by new data coming in, allowing the unit to always keep the more recent data.

14. The GNSS data acquisition unit of claim 9, further comprising:
a trigger from an external source that will cause said digital samples to start or stopped being collected.

15. The GNSS data acquisition unit of claim 14, wherein:
if a time stamp information is accurate enough to determine whether a trigger event occurs within a time interval with high probability of having no bit transition, a device is used to postpone data acquisition to a time window where bit transitions do have higher probability of occurring.

16. The GNSS data acquisition unit of claim 14, wherein:
a dual data capture includes a first capture at the instant of the trigger, and a second capture is done later in time during a more favorable time window to be analyzed to extract precise time information, and such precise time is used to line up said first data capture with a GNSS signal to within one millisecond, the duration of the PN code, by determining the amount of time that elapsed between a first and second data capture, and whereby a geo-location of said first data capture, at the instant of the trigger, can thus be determined precisely by analyzing the second data capture to extract fine timing information.

17. The GNSS data acquisition unit of claim 14, wherein:
if a time stamp is not accurate enough to determine whether a trigger occurs during an unfavorable time window, or if there is no time stamp at all, then a data capture time duration is extended to increase a probability of occurrence of a bit transition within a data capture, and acquisition could take place during multiple relatively short time windows spaced in time so as to maximize a probability of a bit transition occurrence within at least one time window.

18. The GNSS data acquisition unit of claim 14, wherein:
if a previous data acquisition allowed for transmit time extraction and the timestamp information is accurate enough to determine a time interval between earlier and current data captures, the transmit time of the current data capture is determined by adding the time stamp difference to the transmit time obtained from said earlier data capture, and the time interval between the two data captures, associated with a maximum unpredictable time drift of a time stamp, will determine whether a propagated time can be provided with enough accuracy for time extraction.

19. A method for determining a user position, comprising:
obtaining Doppler shift measurements from signals sampled from orbiting navigation satellites;
solving,
$$c \cdot \frac{( {f}_{j} - {f}_{{T}_{j}} )}{{f}_{{T}_{j}}} = \frac{( {{v}^{->}}_{j} - {u}^{{.}^{->}} ) \cdot ( {u}^{->} - {{p}^{->}}_{j} )}{‖ {u}^{->} - {{p}^{->}}_{j} ‖} - c \cdot {\dot{t}}_{u} ,$$
where,
c is the speed of light;
fⱼ is the carrier frequency shift for satellite vehicle #j includes Doppler shift, is measured based on a fine frequency information;
f_{T}_{ⱼ} is the transmitted carrier frequency of satellite vehicle #j, a known;
\vec{v}ⱼ is the vector velocity of satellite vehicle #j—obtained from ephemeris and time information;
{dot over (\vec{u} is the user velocity, assumed to be zero;
\vec{u} is the user position, a principal unknown to be determined;
\vec{p}ⱼ is the position of the satellite vehicle #j, obtained from ephemeris and time information; and
\dot{t}ᵤ is the RF clock frequency offset, an unknown to be determined;
obtaining pseudorange measurements of said orbiting navigation satellites from a user position;
then solving, ρⱼ=∥\vec{p}ⱼ−\vec{u}∥+c·(tᵤ−δtⱼ), where,
ρⱼ is the pseudo range of satellite vehicle #j—measured based on fine codephase and transmit time extraction;
c is the speed of light—known;
\vec{u} the user position—unknown to be determined;
\vec{p}ⱼ is the position of the satellite vehicle #j—obtained from ephemeris and time information;
tᵤ is receiver common clock time offset—unknown to be determined; and
δtⱼ is the clock offset correction for satellite vehicle #j—based on ephemeris information; and
outputting a user position solution.

20. A global navigation satellite system (GNSS) data acquisition unit, comprising:
a memory card for storing digital media recordings;
a radio frequency (RF) front end for the acquisition of navigation satellite signals, and fully disposed in the memory card;
a digital sampler for obtaining digitized samples of said navigation satellite signals, and fully disposed in the memory card;
a timer for limiting how long the RF front end and digital sampler are operated, and fully disposed in the memory card; and
an archive memory for packaging and storing said digitized samples obtained during a limited time into samples records, and fully disposed in the memory card.
